(19) United States
(12) Patent Application Publication
(10) Pub. No.: US 2006/0177561 A1
(43) Pub. Date: Aug. 10, 2006

(54) Foods and drinks containing diacylglycerol

(76) Inventor: Dawn Sikorski, Monticello, IL (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/723,490

(22) Filed: Nov. 26, 2003

Related U.S. Application Data
(60) Provisional application No. 60/520,876, filed on Nov. 18, 2003.

(51) Int. Cl. A23D 9/00

(52) U.S. Cl. 426/607

(57) ABSTRACT

Diacylglycerol (DAG) oil provides unique health and nutritional advantages relative to triacylglycerol (TAG) oils. Food products including baked goods, such as, for example, cake, muffins, brownies, breads and cookies, doughs and batters for baked goods, and drink products are prepared using DAG oil and/or DAG oil-in-water emulsions.

### CROSS REFERENCE TO RELATED APPLICATIONS

This application claims priority under 35 U.S.C. § 119(e) to U.S. Patent Application No. 60/______, entitled “FOODS AND DRINKS CONTAINING DIACYLGLYCEROL,” filed on Nov. 18, 2003, which is incorporated herein by reference in its entirety.

### BACKGROUND

1. Field of the Invention

Food and drink, including baked goods such as cake, muffins, brownies, bread, dough and cookies, are provided containing diacylglycerol (DAG) oils.

2. Description of the Related Art

The primary energy sources available from the typical foods, drinks, and/or supplements consumed by most human populations are proteins, sugars and fats. In most diets in the more industrialized countries, high surplus calories often are sourced from higher-fat foods. Much modern medical research suggests that high fat/lipid diets, particularly those high in cholesterol, trans and saturated fatty acids, and triglycerides, can contribute significantly to the development of many diseases, and particularly heart disease, atherosclerosis, high blood pressure, and other cardiovascular diseases. In addition, other disease states, such as cancer, and a general tendency toward obesity in certain populations, are at least in part traceable to diets containing excess fats/lipids.

An alternate source of fat that can provide the gustatory benefits discerned in typical high fat foods (richness, fatty savor, pleasant mouth feel, and other organoleptic characteristics typically enjoyed in higher fat foods) is DAG oil. Diglyceride oils are described generally in numerous patents, including, for example, U.S. Pat. Nos. 5,160,759; 6,287,624; and laid-open Japanese patents JP-A 63-301754, JP-A 5-168142 and JP-A 60180. In particular, U.S. Pat. No. 5,160,759 describes oil-in-water emulsions comprising diglyceride oils. U.S. Pat. No. 6,361,980 discloses an enzyme-based process useful for the production of such diglycerides. These patents also demonstrate the health benefits that can be achieved by eating DAG-containing food products.

U.S. patent application Ser. No. 10/429,260, incorporated herein by reference in its entirety, describes a number of foodstuffs prepared using DAG oils, including sauces and salad dressings. Baked goods containing DAG oils are disclosed in that reference, but no mention is made therein of specific DAG-containing baked goods having physical and gustatory attributes in common with conventional baked goods, such as commercially-available baked goods containing triacylglycerol (TAG).

Diacylglycerols are naturally occurring compounds found in many edible oils. Through interesterification, an edible oil containing increased level of DAGs has been produced that shows different metabolic effects compared to conventional edible oils. Differences in metabolic pathways between 1,3 diacylglycerol and either 1,2 diacylglycerol or triglycerides allow a greater portion of fatty acids from 1,3 diacylglycerol to be burned as energy rather than being stored as fat. Clinical studies have shown that regular consumption of DAG oil as part of a sensible diet can help individuals to manage their body weight and body fat. In addition, metabolism of 1,3 diacylglycerol reduces circulating postmeal triglycerides in the bloodstream. Since obesity and elevated blood lipids are associated as risk factors for chronic diseases including cardiovascular disease and Type II diabetes, these lifestyle-related health conditions may be favorably impacted through regular consumption of DAG oils.

### SUMMARY

Food and drink products are described herein containing DAG oil in place of TAG oil/fat, or containing oil-in-water emulsions including DAG oil in place of TAG oil/fat. Such food and drink products described herein include baked goods (including, without limitation, cake, muffins, brownies, cookies and bread and cake, muffin, brownie, cookie or bread dough), prepared foods, food ingredients, drinks (including without limitation, meal replacement, energy and nutritional beverages), and nutritional and/or health food products (including, without limitation, health bars, nutritional bars and the like).

Any oil-containing food products could benefit from the use of DAG oil. Food and drink products contemplated within the scope of the present invention may benefit, in the sense of appeal to the consumer's palate, from a higher fat content. In one embodiment, the DAG oil component comprises 1,3-diglycerides in an amount from about 40% to about 100% by weight, more preferably at least about 40%, more preferably at least about 45%, more preferably at least about 50%, more preferably at least about 55%, more preferably at least about 60%, more preferably at least about 65%, more preferably at least about 70%, more preferably at least about 75%, more preferably at least about 80%, more preferably at least about 85%, more preferably at least about 90%, and more preferably at least about 95% by weight. In another embodiment, unsaturated fatty acids account for about 50% to about 100% by weight, more preferably at least about 50%, more preferably at least about 55%, more preferably at least about 60%, more preferably at least about 65%, more preferably at least about 70%, more preferably at least about 75%, more preferably at least about 80%, more preferably at least about 85%, more preferably at least about 90%, more preferably at least about 93%, and more preferably at least about 95% by weight of the fatty acid components in the 1,3-diglycerides in the DAG oil. In a further embodiment, the invention is directed to food and drink products containing oil wherein said oil component comprises DAG oil and TAG oil/fat in a ratio of DAG oil to TAG oil/fat from about 1:100 to about 100:0 (100% DAG oil and no TAG oil/fat), preferably from about 1:50, about 1:20, about 1:10, about 1:5, about 1:4, about 1:3, about 1:2, about 1:1, about 2:1, about 3:1, about 4:1, about 5:1, about 10:1, about 20:1, about 50:1, and about 100:1 to about 100:0. The DAG oil can be provided as an emulsion. The food and drink products therefore containing DAG oil and an emulsifier, such as, without limitation, standard lecithin, acetylated lecithin, hydroxylated lecithin, modified lecithin, sodium stearoyl lactate, and sodium stearoyl lactate in combination with at least one material selected from the group consisting of distilled monoglycerides, monodiglycerides, ethoxylated monoglycerides, monodiglycerides, polysorbates, polyglycerol esters, PGPR, sucrose esters, succinylated monoglycerides, acetylated monoglycerides, lactylated monoglycerides, sorbitan esters, diacetyl tartrate esters of monoglycerides (DATEMs), soy protein isolate, soy protein concentrate, soy protein flour, whey protein isolate, whey protein concentrate, sodium caseinate, and calcium caseinate.

Also provided is a method of preparing a food product including preparing a dough or batter including DAG oil and the product of that method. The dough or batter may be processed into a finished food product. In another embodiment, a method of improving health benefits of a fat/oil-containing food product selected from the group consisting of a cake, a cake batter, a muffin, a muffin batter, a brownie, a brownie batter, a bread, a bread dough, a cookie, and a cookie dough is provided. The method includes preparing the food product with fat/oil comprising diacylglycerol oil.

### BRIEF DESCRIPTION OF FIGURES

The foregoing and other features and advantages of the invention will be apparent from the following, more particular descriptions of embodiments of the invention, as illustrated in the accompanying drawings:

FIG. 1A provides data and graphs showing the degree of emulsion stability for TAG oils and DAG oils in combination with high HLB emulsifiers after 48 hours and provides a graph showing emulsion stability of DAG versus TAG in combination with high HLB emulsifiers.

FIG. 1B is a graph showing emulsion stability of DAG versus TAG in combination with sodium stearoyl lactate (SSL).

FIG. 1C is a graph showing emulsion stability of DAG in combination with high HLB emulsifiers.

FIG. 1D is a graph showing emulsion stability of TAG in combination with high HLB emulsifiers.

FIG. 2A provides data and graphs showing the degree of emulsion stability for TAG oils and DAG oils in combination with lecithin emulsifiers after 48 hours.

FIG. 2B is a graph showing emulsion stability of DAG in combination with high HLB lecithin emulsifiers.

FIG. 2C is a graph showing emulsion stability of TAG in combination with high HLB lecithin emulsifiers.

FIG. 3 provides data and graphs showing the degree of emulsion stability for TAG oils and DAG oils after 48 hours and provides a graph showing emulsion stability of DAG versus TAG in combination with SSL (oil phase) and CCB (Distilled monoglyceride+SSL).

### DETAILED DESCRIPTION OF EMBODIMENTS OF THE INVENTION

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

The food and drink products of the present invention provide the gustatory and/or organoleptic benefits of typical high-fat foods, without the negative health impacts, through use of DAG oils in place of TAG oils. Consumption of DAG oil can take place through a variety of means, such as through use of DAG oil in mayonnaise, sauces, gravies, and as a cooking oil in baked goods.

Formulating baked goods with DAG oil can yield a variety of advantages. In addition to the health benefits associated with DAG oil consumption, the amount of saturated fat in these products can be reduced and replaced with an oil lower in saturates and higher in polyunsaturates. DAG-containing products retain their flavor profile, allowing consumers to enjoy eating their favorite items without sacrificing taste. Baked goods and nutritional drinks formulated with DAG oil were similar in appearance, taste, and texture to their TAG oil controls, especially in baked products with higher fat content.

DAG oils, such as ECONA® (Kao Corporation of Japan) and ENOVA™ (Archer-Daniels-Midland Co., Decatur, Ill. [“ADM”]), are described in United States Patent Publication No. 20030104109, which is incorporated herein by reference in its entirety, and are used in the preparation of oil-in-water emulsions, using any number of commercially available art-recognized emulsifiers. For example, emulsifiers such as lecithin (standard, acetylated, hydroxylated, and/or modified), SSL and SSL combinations with distilled monoglycerides, ethoxylated monoglycerides, monodiglycerides, polysorbates, polyglycerol esters, sucrose esters, succinylated monoglycerides, acetylated monoglycerides, lactylated monoglycerides, sorbitan esters, DATEMs, polyglycerol polyricinoleate (PGPR), and the like may be used in the practice of the present invention. Proteins such as whey protein concentrate/isolate, soy protein isolate/concentrate/flour, and sodium/calcium caseinate can also act as emulsifiers. Of course, as those skilled in the art will recognize, certain emulsifiers will be more or less appropriate to the formulation of certain food and/or drink/beverage products.

Such oil-in-water emulsions are prepared using art-recognized methods, typically using high speed mixing, shear, and/or homogenization. Emulsifiers are mixed or, if not in the aqueous phase, are melted into the oil phase and the oil/emulsifier mixture is slowly added to the aqueous phase under agitation and/or shear.

Such emulsions prepared with DAG oil typically display a high degree of emulsion stability; stability that is, in fact, in many instances improved over TAG oil emulsions, based on the quantity of emulsion interface remaining after 48 hours. Indeed, certain of the emulsions used in the present invention provided 10%-40% improved stability, depending on the type and amount of emulsifier used. The improvements were particularly noteworthy when standard lecithin or SSL were used with DAG oil.

Oil-in-water emulsions, such as those mentioned above, are present in a variety of food systems, including, for example, salad dressings, coffee whiteners, nutritional drinks/beverages, sauces, gravies, marinades, rubs, caramel, confections, yogurt, and the like. In addition, the inventors also have demonstrated that DAG oil may be directly substituted, in whole or in part, for TAG oil in numerous food product formulations, such as baked goods and nutritional bars.

Having now provided a general description of the invention, in various embodiments, the following examples are provided to more particularly illustrate certain non-limiting embodiments within the present invention. Thus, these examples are intended to be descriptive and explanatory, and are not intended to limit the scope of the invention as set forth in the appended claims.

### EXAMPLE 1

### Oil-In-Water (O/W) Emulsions

Materials

Emulsifiers (Added at 0.5-1.5%, based on weight of added oil=0.525-1.575 g per treatment):

Standard Lecithin (Fluid)-Yelkin TS-ADM

Acetylated Lecithin-Thermolec 200-ADM

Acetylated, Hydroxylated Lecithin-Thermolec WFC-ADM

Hydroxylated Lecithin-Yelkin 1018-ADM

Enzyme Modified Lecithin (Lysolecithin)-Blendmax K-Central Soya

Complexed Lecithin-Performix E-ADM (standard lecithin+ethoxylated monodiglycerides)

Sunflower Oil Monoglycerides from Traditional Sunflower Oil-DMG 130-ADM

Sunflower Oil Monoglycerides from Mid-Oleic Sunflower Oil-DMG 130-ADM (discontinued product)

SSL-Paniplex SK-ADM

CCB-Distilled monoglyceride+SSL-ADM (experimental product)

Ethoxylated Monodiglycerides-Mazol 80 K (same ethoxylated monodiglyceride used in Performix E)-BASF Corp.

Polysorbate 60 and 80-ADM Packaged Oils and Sigma Chemical, respectively

Oils (Added at 35% total formulation weight, or 105 g per treatment):

Control: 70/30 Soybean oil/Canola oil mixture (to ensure fatty acid composition of vegetable oil vs. DAG oil remained constant (not a source of variability)).

Test: Econa® oil from Kao Corporation of Japan. Oil was tested with no additives to ensure functional differences were attributable to oil source only.

Water (Added at 63.5-64.5%, depending on amount of emulsifier added, or 190.5-193.5 g per treatment): Deionized water

All emulsions were made at room temperature (25° C.). Emulsifiers were pre-dispersed in oil before emulsions were made. If emulsifier was not liquid at room temperature or if partial solidification of the emulsifier was observed when combined with oil, samples were heated using a hot plate with stirring capability. Heating was carried out until emulsifier was fully melted in the oil phase; temperature of heating depended on melt point of the individual emulsifier. Samples were then cooled to 25° C.

Emulsion Procedure was as Follows:

Distilled water was weighed into 400 ml Nalgene beaker. Emulsification was begun using high shear mixer (PowerGen 700 Fisher Scientific) on setting # 1.5. When mixer was fully up to speed, oil/emulsifier mixture was added slowly (time of addition was approximately 30 seconds). After addition of the oil/emulsifier mixture was completed, the mixture was mixed on setting # 1.5 for 30 seconds, moving container in a circular motion to ensure a homogeneous distribution. After mixing the contents were decanted into a clear 250 ml glass graduated cylinder. Levels of oil, water, and emulsion interface were monitored for 15 minutes, 30 minutes, 45 minutes, 1 hour, 4 hours, 24 hours, and 48 hours after initial preparation.

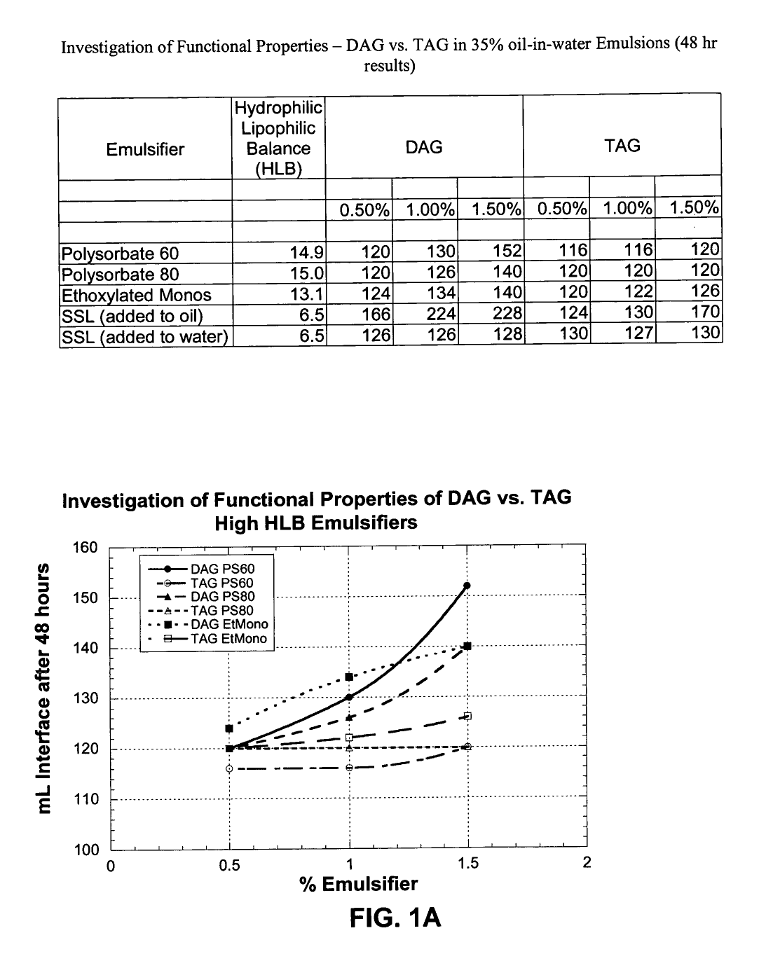

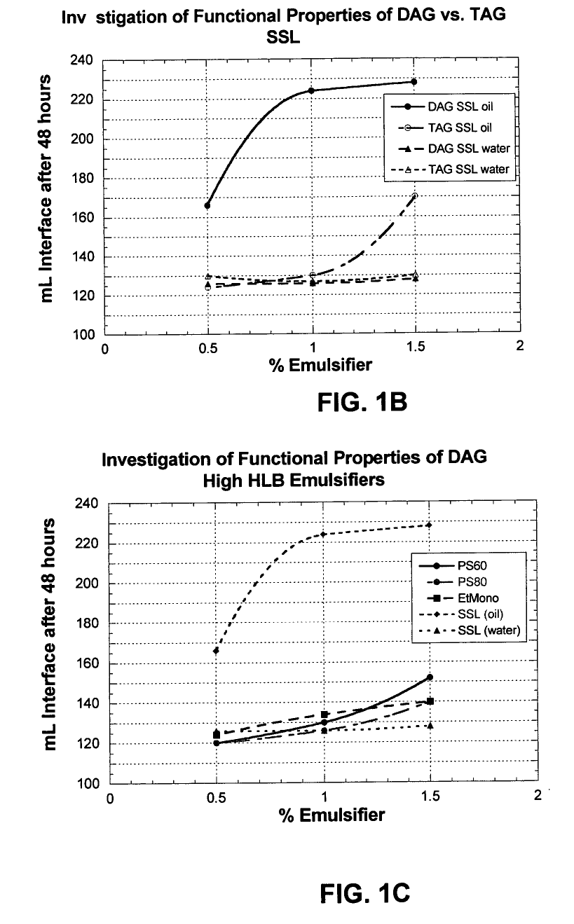

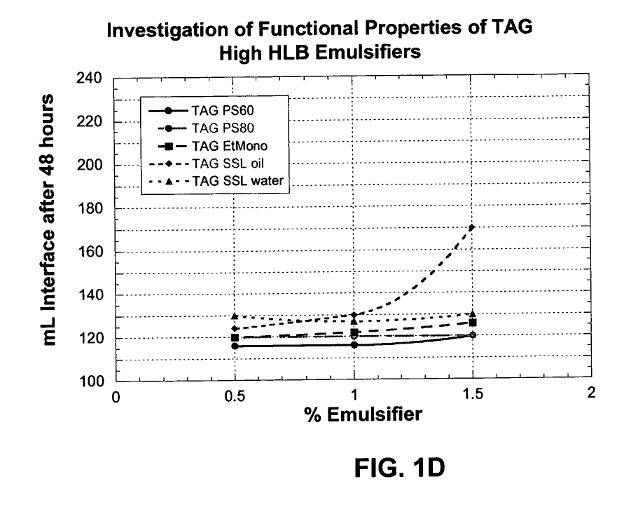

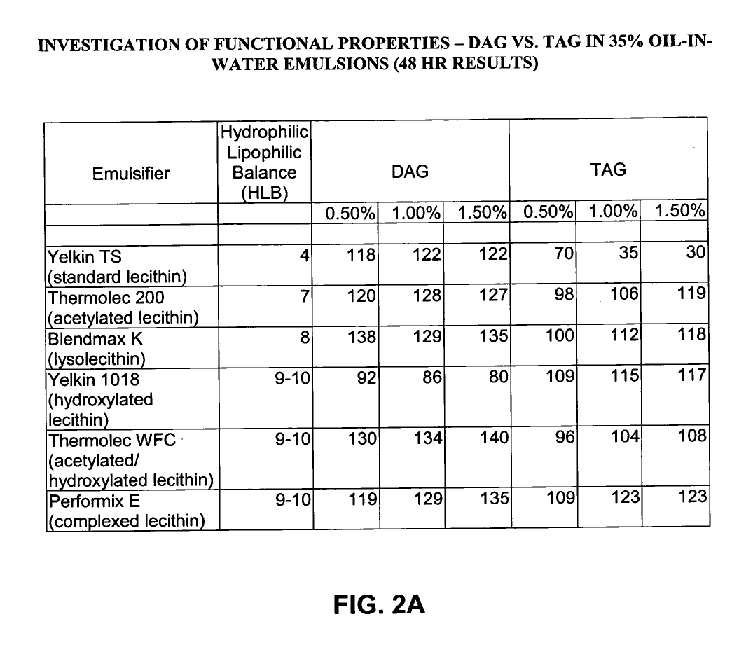

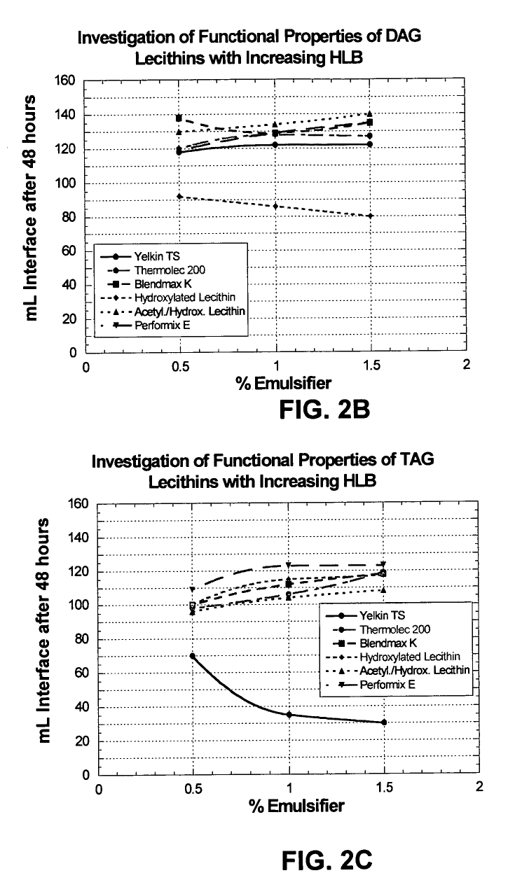

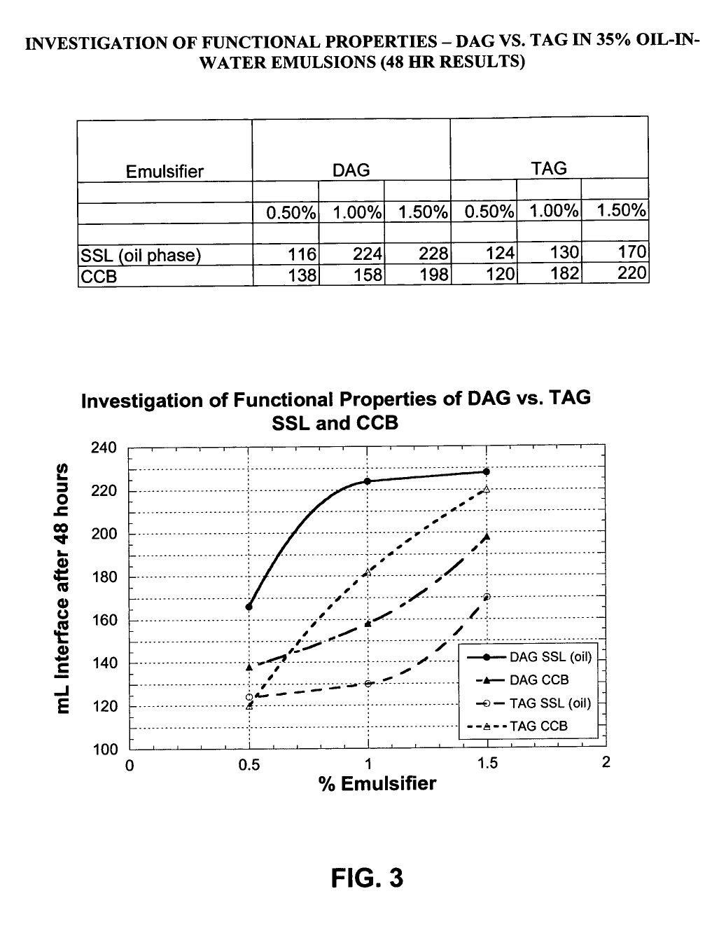

In general, as shown in FIGS. 1-3, emulsions made with DAG oil displayed a higher degree of emulsion stability than the TAG oil controls, as seen by quantity of emulsion interface remaining after 48 hours. Difference in emulsion stability was 10%-40% greater in DAG compared to TAG, depending on type and level of emulsifier used. Differences seen between emulsions formed when standard lecithin or SSL were used were particularly noteworthy in DAG.

DAG oil will not compromise oil-in-water emulsion systems. In fact, results indicate that using DAG oil improves emulsion stability, translating to either lower usage of emulsifiers or increased emulsion stability for longer storage/shelf life of these foods. Applicable oil-in-water food systems include, for example, salad dressings, coffee whitener, nutritional drinks/beverages, sauces, gravies, marinades, rubs, caramel, confections, and yogurt.

Baked Goods

Cakes, muffins, brownies, and cookies were prepared using DAG oils, alone or in combination with TAG-containing oils/fats, as described below. The data provided below demonstrate that use of DAG, alone or in combination with other fats, as well as other ingredients, such as, without limitation, emulsifiers and gums, in cakes, muffins, brownies and cookies results in substantially the same or superior physical and organoleptic characteristics as compared to such baked goods prepared with conventional fats. Breads and dough, such as pizza dough, breadsticks, bagels or rolls also may be prepared using DAG oil. The baked good examples below utilize a TAG oil composed of 53.3% safflower oil, 43.9% canola oil, and 2.8% flax oil. This oil blend was used to approximate the fatty acid composition of the DAG oil. The DAG oil used in the Examples below was, a mixture of soybean and canola oils treated with a 1,3 specific lipase according to United States Patent Publication No. 20030104109, which is available under one of the ENOVA and ECONA trademarks.

All parameters measured in the experiments below were measured by industry-standard methods. In short, physical parameters, including gumminess, springiness, cohesiveness, resilience and hardness were measured using a TA-XT plus texture analyzer (Texture Technologies, Scarsdale, N.Y.) equipped with Texture Expert Software. Cookie spread factor was measured by ACCC Method 10-50 D. Water activity was measured using an Aqualab Series 3 TE Water Activity Meter. Percent H₂O was measured using a Mettler LP16 drying oven and a Mettler PM 100 balance. Texture average was measured using the AIB Standard Method for Cookie Hardness. Readings for cookie texture are the average of six independent readings.

### EXAMPLE 2

### Scratch Formula-110% Sugar Cake Mix

The scratch formula tested was a high ratio yellow cake including 110% by weight of flour sugar, 45% by weight of flour fat (shortening+oil+emulsifiers), and 100% cake flour. All-purpose shortening was used as the plastic shortening in all trials; either DAG oil or TAG oil was used as the liquid oil source in the trials. Plastic shortening accounted for 50-70% and liquid oil accounted for 30-50% of the fat source used, depending on the trial. In addition, a plastic emulsifier system consisting of propylene glycol monoesters, mono and diglycerides, SSL, and lecithin was added to the blend of shortening and liquid oil to provide similar emulsification and air incorporation characteristics to what is currently used in the industry. The shortening, liquid oil, and emulsifier system were creamed together prior to addition of any dry ingredients to ensure appropriate dispersion and mixing between the ingredients; in other words, the modified shortening/fluid shortening of interest was made in situ prior to addition of dry ingredients. Because the yellow cake formula is the base formula upon which all scratch cakes are built, it was reasoned that testing performance differences between DAG oil and TAG oil in this type of formula would indicate how performance would be affected in other model cake systems using a 110% sugar formula as a base.

Mixing for scratch preparations occurred in three stages after the shortening/fluid shortening of interest was made. In the first stage, the shortening, emulsifier, and liquid oil mixture was creamed with the dry ingredients and 78% of the water to facilitate dispersion of fat and incorporation of air. Eggs and remaining water were added in the second and third stages, scraping the bowl after each mixing stage. After measuring specific gravity, batter was poured into pans, maintaining a constant weight of batter in each pan, and baked. After sufficient cooling, cakes were depanned and allowed to thoroughly cool prior to reading volume. After volume measurements were made, cakes were stored in plastic bags. Texture was determined one day after initial manufacture; parameters evaluated were hardness, gumminess, cohesiveness, springiness, and resilience.

Slight differences in volume and texture were seen when DAG oil was used to replace TAG oil in modified fluid shortening systems shown in Table A. In general, cakes made with DAG oil had lower volume, but had softer texture and were less gummy than cakes made with TAG oil. Cakes made utilizing 30%, 40%, or 50% DAG oil with remainder being all-purpose shortening in the fluid shortening systems were 5.5%, 5.9%, and 3.0% lower in volume, respectively, than cakes made with TAG oil. Relatively slight differences were seen in softness and gumminess scores between the DAG- and TAG-containing cakes when 30% DAG oil was used, whereas differences in softness and gumminess scores were more marked at the 50% DAG levels.

Though lower cake volumes usually lead to increased hardness and gumminess values, the difference between expected and actual results possibly may be explained by examining the differences in polarity between DAG oil and TAG oil. Because DAG oil is more polar than TAG oil, it has a higher degree of interaction in the aqueous phase. Consequently, when it is used in combination with shortening to encapsulate/incorporate air cells, segregation of air cells from the aqueous phase is not as complete as when TAG oil is used. As a result, air has greater mobility within the aqueous phase prior to gelatinization of the starches during baking. Increased mobility of air within the aqueous phase leads to formation of larger air cells, which are more sensitive to collapse and more susceptible to being dissolved out of the batter, either of which are known to negatively impact volume. Though interaction with the aqueous phase resulted in slightly lower cake volumes, it improved the water holding capacity of the batter. Because water holding capacity was improved, a positive impact was observed in texture in the cakes made with DAG oil (lower hardness and gumminess scores).

Again, referring to Table A, it is seen that at higher inclusion levels of DAG oil, less difference was seen in finished cake volume between cakes made with DAG oil and TAG oil; in addition, texture was proportionally softer and less gummy than the corresponding cakes made with TAG oil. Differences in volume and texture between cakes made with DAG and TAG oils at higher use levels are believed to be caused by a combination of increased batter viscosity and increased polarity of DAG relative to TAG. Though a slight increase in batter viscosity was observed in all DAG oil treatments relative to the TAG oil treatments tested, the effect of increased viscosity on maintaining volume was minimal until higher levels of liquid oil were used.

Use of higher levels of liquid oil resulted in lower overall batter viscosities. Because the cake batter made with DAG oil had a higher viscosity than the cake batter made with TAG oil, mobility and increased presence of air in the aqueous phase was offset by reduced mobility of the aqueous phase, thereby reducing overall air loss and minimizing differences seen in volume between the two treatments. Because a higher amount of DAG oil is present in the batter and the increased polarity of DAG relative to TAG improves water holding capacity of the batter, greater differences in hardness and gumminess values were observed over differences seen at lower inclusion rates of DAG.

Though it is believed that the differences in volume between cakes made with DAG oil and TAG oil would be within the acceptable range of variation for a manufacturer, it is believed that one could restore volume in cakes made with DAG oil to levels seen in cakes made with TAG oil by one or more of the following options: modification of the leavening acid, increased level of leavening agents, small additions of hydrocolloid gums, modification of the emulsification system, and/or modification of mixing conditions. By modifying the leavening acid, one could better control the time at which leavening gasses are released and subsequent expansion of the batter takes place. By delaying expansion of the batter until closer to the gelatinization point of starch, air loss can be minimized through retention of existing air cells, thereby restoring volume. Increasing the level of leavening agents added would increase formation of air cells in the batter, thereby restoring volume. However, care must be taken to not add too much leavening agent, as high levels of leavening agent will yield textural defects in the finished cake.

Small additions of a hydrocolloid like xanthan gum may provide increased batter viscosity during the bake cycle, reducing mobility of entrapped air, enabling a higher amount of small air cells to be retained in the batter, thereby restoring volume. Due to the hydrophilic nature of hydrocolloid gums, care must be taken in choosing the appropriate use level for the gum. If the use level selected is too high, too much water will be held in the cake, which could lead to a gummy texture or increase the possibility of mold growth during shelf life. Modification of the emulsification system may help to provide a more stable structure for air entrapment that is less active in the water phase. Reduced activity in the water phase will help to immobilize the air until the shortening melts during the baking cycle. Reduced mobility of the air will enable a higher amount of small air cells to be retained within the batter, thereby restoring volume. Finally, modification of mixing conditions could also be employed. By increasing the mixing time, higher levels of air incorporation could be achieved, thereby restoring volume. However, modification of mix time must be closely examined as increases in mix time could lead to overdevelopment of gluten, yielding a tough cake with a coarse grain.

TABLE A
110% Sugar Scratch Cakes - Mean and Standard Deviation for Textural Attributes

| % Shortening/ | Volume (mm²) | | Hardness (g) | | Gumminess | | Springiness | | Cohesiveness | | Resilience | |
|---|---|---|---|---|---|---|---|---|---|---|---|---|
| % Oil Ratio* | Mean | Std. Dev. | Mean | Std. Dev. | Mean | Std. Dev. | Mean | Std. Dev. | Mean | Std. Dev. | Mean | Std. Dev. |
| 70/30 DAG | 746.9 | 14.98 | 610.85 | 55.03 | 475.20 | 40.43 | 0.855 | 0.046 | 0.778 | 0.005 | 0.473 | 0.006 |
| 70/30 TAG | 790.7 | 9.28 | 699.54 | 51.72 | 551.98 | 39.12 | 0.908 | 0.020 | 0.789 | 0.013 | 0.484 | 0.011 |
| 60/40 DAG | 780.0 | 9.30 | 548.01 | 81.51 | 425.96 | 57.24 | 0.846 | 0.130 | 0.779 | 0.021 | 0.466 | 0.023 |
| 60/40 TAG | 828.8 | 6.43 | 627.76 | 18.08 | 477.17 | 18.69 | 0.855 | 0.043 | 0.760 | 0.017 | 0.452 | 0.019 |
| 50/50 DAG | 777.1 | 40.01 | 509.12 | 13.31 | 400.81 | 12.50 | 0.899 | 0.035 | 0.787 | 0.006 | 0.465 | 0.004 |
| 50/50 TAG | 801.5 | 8.68 | 675.36 | 24.68 | 530.32 | 24.66 | 0.915 | 0.036 | 0.785 | 0.016 | 0.483 | 0.021 |

*For the shortening/oil blends, all-purpose shortening was used as the shortening fraction and either DAG or TAG oil was used as the oil fraction

### EXAMPLE 3

### Box Cake Mixes

Box mix formulas tested were white, yellow, and devil's food cake. Due to differences in polarity between DAG oil and TAG oil, white cake was tested to determine if functional differences existed when egg whites were used, yellow cake was tested to determine if functional differences existed when whole eggs were used, and devil's food cake was tested to determine if functional differences existed with addition of chocolate and lower mixing time. For preparation of box mixes, trials on each type of cake were done in independent triplicate to provide data sufficient to determine if differences existed between DAG oil and TAG oil treatments. Because a high degree of variability can exist between the performance of individual box mixes, dry mixes for DAG oil and TAG oil treatments were weighed, combined in one mixing bowl, blended to ensure homogeneity of ingredients, and divided equally prior to adding liquids. After a uniform dry mix was obtained for each treatment, equal amounts of oil (either DAG or TAG), eggs (weighed, mixed together, and divided equally between each treatment), and water were added to each treatment and mixed according to directions on the box. After measuring specific gravity, batter was poured into pans, maintaining a constant weight of batter in each pan, and baked. After sufficient cooling, cakes were depanned and allowed to cool thoroughly prior to reading volume. After volume measurements were made, cakes were stored in plastic bags. Texture was determined one day after initial manufacture; parameters evaluated were hardness, gumminess, cohesiveness, springiness, and resilience. Differences in volume and texture between the individual treatments were determined by least significant difference at the 95% confidence level.

Results obtained for white cake made from box mixes showed no statistically significant differences in volume, hardness, gumminess, springiness, or cohesiveness between cakes made with DAG and TAG oils (Table B). However, the cakes made with DAG oil were statistically more resilient than the cakes made with TAG oil. Results indicate that both liquid oils have similar interaction with the emulsifiers and egg whites used in the formula.

Though results were similar when DAG oil was used to replace TAG oil in white cakes, more differences were seen when DAG oil was used to replace TAG oil in yellow cakes (Table B). Yellow cakes made with DAG oil were statistically harder, more gummy, more cohesive, and more resilient than yellow cakes made with TAG oil. Volume and springiness were statistically the same in both treatments. Because the main difference between the white cake and yellow cake formula was the use of egg whites versus whole eggs, respectively, it was reasoned that differences seen in hardness, gumminess, and cohesiveness between the two oils likely was due to a difference in their interaction with the egg yolk phospholipids. Because DAG oil has a higher polarity than TAG oil, it can solubilize more of the egg yolk phospholipids, reducing their ability to act as emulsifying and tenderizing agents. Consequently, hardness of the cake made with DAG oil increases. Since fewer of the egg yolk phospholipids orient themselves at the interface between water and oil to reduce surface tension and provide emulsification, more are able to participate in interactions with free water in the system, increasing water holding capacity and gumminess of the cake. Increased water holding capacity makes the cake more cohesive, causing it to disintegrate/break down in the mouth more slowly. It should be noted that increased gumminess resulted from using both DAG oil and hydrocolloid gums in this cake. Hydrocolloid gums were present in the base mix. Since both DAG oil and hydrocolloids absorbed water, the amount of water necessary to provide softness was exceeded, resulting in gumminess. When no hydrocolloids were used (in 110% sugar scratch cake formula), increased water holding capacity from DAG oil led to increased softness and reduced gumminess scores.

Despite the differences seen in mechanical texture analysis, no significant differences were seen between cakes made with DAG or TAG oils when presented to consumers in a triangle test. Therefore, though some significant differences were detected between the texture of the cakes made with DAG oil and TAG oil, differences were minor as judged by actual consumers of the two products.

Results obtained for devil's food cake made from box mixes showed no differences in volume, hardness, gumminess, springiness, or cohesiveness between cakes made with DAG and TAG oils (Table B). However, the cakes made with DAG oil were statistically more resilient than the cakes made with TAG oil. Results indicate that both liquid oils have similar interaction with the emulsifiers and alkalized cocoa used in the formula. Though the similarity in texture was unexpected considering the results obtained for DAG and TAG oils in yellow cake, a possible explanation for the observations is as follows. Due to reductions in both mixing speed and mixing time for devil's food cake as compared to yellow cake, less gluten development occurred. Because gluten was not developed to the same extent in devil's food cake as in yellow cake, less tenderization from the egg yolk phospholipids was required; therefore, differences in hardness between devil's food cakes made with DAG oil or TAG oil were minimal. Since no differences were seen in gumminess or cohesiveness of devil's food cakes made with DAG or TAG oil, the egg yolk phospholipids were most likely interacting with the cocoa particles in the formula. Interaction with the cocoa reduced the amount of phospholipid in the DAG oil; consequently, water holding capacity of the DAG oil was reduced to a similar level as was seen in TAG oil, thus minimizing differences in gumminess between the two treatments. Since no difference was observed in gumminess, the cakes disintegrated in the mouth in a similar fashion; therefore, no differences were seen in cohesiveness between the two treatments.

Though some differences between the performance of DAG oil and triacylglycerol oil in cakes appear to be dependent upon the particular formulation tested, one parameter which was consistent among all formulation types was resilience. White, yellow, and devil's food cakes made with DAG oil were all found to be significantly more resilient than the same cakes made with TAG oil. Increased resilience of cakes made with DAG oil was most likely due to a combination of the difference in polarity and interfacial tension between DAG and TAG oils. Because DAG oil has one-half the interfacial tension of TAG oil, it could be more easily emulsified when equal shear rates were applied. In addition, increased polarity of DAG oil relative to TAG oil increased the ability of DAG oil to be more interactive in the aqueous phase. Thus, improvement in emulsification characteristics and interaction in the aqueous phase enabled a more stable foam to be created, which improved resilience. Improved resilience is particularly important for box mix cakes, since these cakes are usually more delicate and susceptible to damage than cakes made from multistage mixing processes. Therefore, using DAG oil to replace TAG oil could be advantageous in box mix cakes.

TABLE B
Box Mix Cakes - LSD Means for Textural Attributes

| | Volume (mm²) | | Hardness (g) | | Gumminess | | Springiness | | Cohesiveness | | Resilience | |
|---|---|---|---|---|---|---|---|---|---|---|---|---|
| Cake Type | DAG | TAG | DAG | TAG | DAG | TAG | DAG | TAG | DAG | TAG | DAG | TAG |
| White | 718.7^{a} | 731.2^{a} | 454.42^{a} | 429.81^{a} | 337.83^{a} | 308.32^{a} | 0.947^{a} | 0.962^{a} | 0.743^{a} | 0.717^{a} | 0.419^{a} | 0.379^{b} |
| Yellow | 860.9^{a} | 867.3^{a} | 483.66^{a} | 373.73^{b} | 383.72^{a} | 286.49^{b} | 0.961^{a} | 0.959^{a} | 0.794^{a} | 0.767^{b} | 0.472^{a} | 0.429^{b} |
| Devil's Food | 748.7^{a} | 755.6^{a} | 559.69^{a} | 544.80^{a} | 457.71^{a} | 426.13^{a} | 0.988^{a} | 0.975^{a} | 0.823^{a} | 0.782^{a} | 0.503^{a} | 0.468^{b} |

Note:
For each individual attribute, mean values with different letters denote significant differences at the 95% confidence level

### EXAMPLE 4

### Muffins

Though muffins have been thought of strictly as breakfast items in the past, their convenience and portability have made them popular snack choices at virtually any time of the day. Because consumption of muffins has become more popular within the recent years, it is important to offer healthier alternatives to these products. Healthier alternatives mean healthier snacking, which is of keen interest in light of the rise in obesity and complications from obesity-related diseases. By combining the nutritional benefits associated with DAG oil consumption and the portability and convenience of muffins, a healthier alternative to traditional high fat snacks could be offered to consumers to help them meet their weight management goals. Muffin formulations are similar to high ratio cakes; however, muffins are typically less sweet and have lower levels of fat than are commonly found in most high ratio cakes. In addition, muffins are more dense and have a chewier texture than their high ratio cake counterparts.

To test the functional properties of DAG oil in muffins, both apple streusel muffins and banana muffins were selected. Both were made using box mix formulas and single stage mixing procedures. The apple streusel muffin formulation was selected to determine if differences in polarity between DAG oil and TAG oil affected suspension of inclusions, while the banana muffin formulation was selected to determine if functional properties were altered by high inclusion levels of oil in the mix. Apple inclusions in the apple streusel mix were derived from apple pie filling. The amount of oil added in apple and banana muffins was ¼ cup and ½ cup per mix, respectively. Trials on each mix were done in independent duplicate in order to have sufficient data to determine if differences existed between DAG oil and TAG oil treatments. Because a high degree of variability can exist between the performance of individual box mixes, dry mixes for DAG oil and TAG oil treatments were weighed, combined in one mixing bowl, blended to ensure homogeneity of ingredients, and divided equally prior to adding liquids. After a uniform dry mix was obtained for each treatment, equal amounts of oil (either DAG or TAG), eggs (weighed, mixed together, and divided equally between each treatment), inclusions (if applicable), and water (or milk) were added to each treatment and mixed according to directions on the box. After measuring specific gravity, batter was poured into paper muffin cups, maintaining a constant weight of batter in each cup, and baked. After sufficient cooling, muffins were depanned and allowed to cool thoroughly prior to reading volume. After volume measurements were made, muffins were stored in plastic bags. Texture was determined one day after initial manufacture; parameters evaluated were hardness, gumminess, cohesiveness, springiness, and resilience. Differences in volume and texture between the individual treatments were determined by least significant difference at the 95% confidence level.

Results obtained for both apple streusel and banana muffins made from box mixes showed no significant differences in volume, hardness, gumminess, springiness, cohesiveness, or resilience between the DAG oil and TAG oil treatments (Table C). Therefore, use of DAG oil does not appear to significantly affect suspension of inclusions, functional properties, texture, or volume any differently than TAG oil when used in the formulations tested, even at high inclusion levels of oil. To confirm experimental results, the banana muffins made with DAG and TAG oils were tested by a consumer panel to see if any differences could be detected upon actual consumption of the product. Panelists were asked to identify the samples in a triangle test. Results from the consumer panel showed no significant difference between the samples including DAG oil or TAG oil.

TABLE C
Box Mix Muffins - LSD Means for Textural Attributes

| | Volume (mm²) | | Hardness (g) | | Gumminess | | Springiness | | Cohesiveness | | Resilience | |
|---|---|---|---|---|---|---|---|---|---|---|---|---|
| Muffin Type | DAG | TAG | DAG | TAG | DAG | TAG | DAG | TAG | DAG | TAG | DAG | TAG |
| Apple | 250.0^{a} | 244.5^{a} | 402.77^{a} | 390.92^{a} | 306.88^{a} | 302.84^{a} | 0.820^{a} | 0.856^{a} | 0.762^{a} | 0.775^{a} | 0.436^{a} | 0.442^{a} |
| Banana | 259.0^{a} | 258.5^{a} | 499.08^{a} | 479.37^{a} | 383.28^{a} | 365.00^{a} | 0.922^{a} | 0.924^{a} | 0.769^{a} | 0.762^{a} | 0.435^{a} | 0.420^{a} |

Note:
For each individual attribute, mean values with different letters denote significant differences at the 95% confidence level

### EXAMPLE 5

### Brownies

Brownie formulations have similar characteristics to both cakes and cookies. They are similar to cakes with respect to the content of sugar and eggs in the formula, but are like cookies with respect to the content of shortening and water in the formula.

Box mix formulas were tested for fudge-type brownies to determine if there were differences in texture or flavor between the brownies made with DAG oil and TAG oil. For preparation of box mixes, trials on the brownies were done in independent triplicate to have sufficient data to determine if significant differences existed between the two treatments. Because a high degree of variability can exist between the performance of individual box mixes, dry mixes for DAG oil and TAG oil treatments were weighed, combined in one mixing bowl, blended to ensure homogeneity of ingredients, and divided equally prior to adding liquids. After a uniform dry mix was obtained for each treatment, equal amounts of oil (either DAG or TAG), eggs (weighed, mixed together, and divided equally between each treatment), and water were added to each treatment and mixed according to directions on the box. After measuring specific gravity, batter was poured into 9″×13″ pans, maintaining a constant weight of batter in each pan, and baked. After sufficient cooling, brownies were depanned and allowed to thoroughly cool prior to packaging in plastic bags. Texture was determined one day after initial manufacture; parameters evaluated were hardness, gumminess, cohesiveness, springiness, and resilience. Differences in texture between the individual treatments were determined by least significant difference at the 95% confidence level.

Results obtained for brownies made from box mixes showed no differences in hardness, resilience, springiness, or cohesiveness between DAG oil and TAG oil treatments (Table D). However, the brownies made with DAG oil were statistically more chewy than the brownies made with TAG oil. Results may be explained by examining the differences in polarity between DAG and TAG oils. Increased polarity of DAG oil relative to TAG oil increases its water holding capacity; increased water holding capacity of DAG oil increases gluten development during mixing, changing the texture of the brownie.

Though texture measurements taken for the brownies made with DAG oil indicated the product was chewier than the brownie made with TAG oil, these results were not confirmed in actual product testing with consumers. When brownies made with DAG oil and TAG oil were compared against each other in a triangle test, consumers could detect differences between the samples. Though they rated the differences as being minor, consumers thought the brownies made with DAG oil were less moist, chewy, and flavorful than the brownies made with TAG oil. Further analysis of their comments and comparisons between the two samples revealed the brownies made with DAG oil were slightly more cake-like in texture than the brownies made with TAG oil, which were perceived as slightly more fudge-like. Because fudge-like brownies are more dense than cake-like brownies, they are judged as being more moist and chewy than cake-like brownies. In addition, the differences in density combined with the differences in gluten development change the order and intensity in which the chocolate notes are perceived. Chocolate notes are more intensely perceived upon initial consumption of brownies made with TAG oil because they are more fudge-like and dense than the brownies made with DAG oil; therefore, the aromatics from the chocolate are more easily released upon consumption of the product made with TAG oil than the product made with DAG oil.

An important side-note to the discussion above was the fact that the same differences were not consistently observed between DAG oil and TAG oil treatments upon repeated evaluations. Additional evaluations comparing the same box mix brownies (from different lots/manufactured at different times) made with DAG oil and TAG oil rated the DAG oil brownies higher in chocolate flavor than the TAG oil brownies. Though the DAG oil brownies were rated higher in overall chocolate flavor, the perception of flavor release occurred later than the perception of chocolate flavor in the TAG oil brownies. Therefore, while release of the chocolate flavor was consistent between treatments, the perception of flavor intensity was inconsistent between the treatments. Differences were also seen in texture between the different lots of brownie mix tested. Some evaluations rated the brownies made with DAG oil as being more chewy and fudge-like, while other evaluations rated the brownies made with DAG oil to be less chewy and more cake-like. Since differences between texture and flavor seemed to vary with the lot of mix being tested, it was reasoned that the lot to lot variability between the mixes is greater than the texture and flavor differences based on the type of oil used in the formula.

TABLE D
Box Mix Brownies - LSD Means for Textural Attributes

| Hardness (g) | | Chewiness | | Springiness | | Cohesiveness | | Resilience | |
|---|---|---|---|---|---|---|---|---|---|
| DAG | TAG | DAG | TAG | DAG | TAG | DAG | TAG | DAG | TAG |
| 967.89^{a} | 780.72^{a} | 232.37^{a} | 209.60^{b} | 0.530^{a} | 0.561^{a} | 0.458^{a} | 0.481^{a} | 0.136^{a} | 0.144^{a} |

Note:
For each individual attribute, mean values with different letters denote significant differences at the 95% confidence level

### EXAMPLE 6

### Cookies

The major reasons why it would be desirable to incorporate DAG oil into baked goods like cookies would be to:
1. Decrease the saturated fats and trans fats currently contained in the cookie
2. Increase the monounsaturated and polyunsaturated fatty acids in the cookie
3. Provide the nutritional benefits associated with DAG oil consumption to consumers to allow them to maintain a healthy body weight while enjoying healthier alternatives to their favorite baked goods

DAG oil can be added as either a partial or complete replacement of the partially hydrogenated shortening typically used in cookie manufacture. It is added at the same stage in the process as the shortening to ensure proper mixing with the shortening and sugar. To determine the optimum inclusion rate of DAG oil in the cookie, a model system for the cookie of interest can be used. Once the desired inclusion rate has been determined, the impact on the flavor system should be investigated. By using a liquid oil to replace part or all of the solid fat originally in the system, perception and release of flavor compounds may be altered. Consequently, minor changes in the flavor system may be required to maintain a similar flavor profile and release of volatile components as compared to the original cookie. In addition to the flavor system, the impact on shelf life should also be considered. Depending on how much liquid oil is incorporated into the system, it may be necessary to use improved packaging materials or additional/different antioxidants, bulking agents, preservatives, or crumb softeners to obtain similar shelf life characteristics. Because functional attributes and desired eating quality vary depending on the type of cookie baked, similar practices would need to be employed to determine the optimum inclusion level, flavor profile, and storage considerations for other cookie types utilizing DAG oil.

To test the concepts illustrated above, work was done using a model sugar cookie formula to examine how utilization of DAG oil affected functional properties, flavor profile, and shelf life in this type of cookie. The sugar cookie formula contained 40% fat, 63% sugar, and 9% protein (all based on flour weight). The dough was prepared using a three stage process. In the first stage, the shortening (or oil, if applicable) was creamed with sugar to facilitate aeration. Eggs were added in the second stage to provide emulsification of the shortening and/or oil with the dry ingredients, which allowed further nucleation of the fat and subsequent incorporation of air. Flavor was also added at this stage because it could be more uniformly dispersed throughout the dough prior to addition of the flour; addition of flour significantly increases viscosity of the dough and would consequently hinder mobility and effective dispersion of minor components like flavor. Flour and water were added in the final mixing stage to minimize gluten development; minimizing gluten development reduces toughness of the dough, which aids in processing and handling the dough as well as providing the desired texture in the finished cookie. After the dough was made, it was chilled for approximately 30 minutes to facilitate handling. The dough was then sheeted (to achieve uniform thickness), cut with a round cookie cutter (to achieve uniform size and shape), and baked. After cookies were completely cooled, they were packaged into foil pouches and stored at room temperature to evaluate shelf life. Dough rheology and ease of machining were evaluated during make-up and manufacture while spread, texture, water activity, and moisture content were evaluated at various time points over shelf life of the cookies.

To determine the effect of DAG oil in cookies, various inclusion levels relative to shortening were examined. Cookies were made in which DAG oil replaced shortening at 25%, 50%, 75% and 100% of the amount of shortening originally contained in the formula. Little difference was seen in make-up, dough viscosity, chill time, or sheeting properties of the dough when 25% DAG oil:75% shortening or 50% DAG oil:50% shortening blends were used. Tables E-I provide dose response data for the use of DAG oil as a shortening replacement in cookies (Note: Spread Factor (as described in AIB Method 10-50 D)=W/T*10).

TABLE E
Shortening:DAG oil = 100:0 25° C.

| Time | AVG | Water | % H₂O | Texture |
|---|---|---|---|---|
| (weeks) | Sprd Fctr | Activity AVG | AVG | AVG |
| 0 | 59.25 | 0.456 | 4.90 | 3141.12 |
| 1 | 54.11 | * | * | 4335.70 |
| 2 | 61.82 | 0.452 | 4.90 | 4593.97 |
| 4 | 55.14 | 0.487 | 4.40 | 4649.14 |
| 8 | 57.85 | 0.629 | 4.84 | 6662.71 |

TABLE F
Shortening:DAG oil = 75:25 25° C.

| Time | AVG | Water | % H₂O | Texture |
|---|---|---|---|---|
| (weeks) | Sprd Fctr | Activity AVG | AVG | AVG |
| 0 | 64.02 | 0.433 | 4.20 | 4091.97 |
| 1 | 61.97 | * | * | 4654.80 |
| 2 | 64.09 | 0.445 | 4.30 | 4398.99 |
| 4 | 66.67 | 0.456 | 3.94 | 4271.93 |
| 8 | 62.63 | 0.520 | 4.15 | 4075.69 |

TABLE G
Shortening:DAG oil = 50:50 25° C.

| Time | AVG | Water | % H₂O | Texture |
|---|---|---|---|---|
| (weeks) | Sprd Fctr | Activity AVG | AVG | AVG |
| 0 | 62.03 | 0.450 | 4.54 | 3020.19 |
| 1 | 61.49 | * | * | 4638.98 |
| 2 | 62.07 | 0.453 | 4.30 | 4200.93 |
| 4 | 63.60 | 0.457 | 4.46 | 4507.96 |
| 8 | 64.03 | 0.513 | 4.39 | 4365.67 |

TABLE H
Shortening:DAG oil = 25:75 25° C.

| Time | AVG | Water | % H₂O | Texture |
|---|---|---|---|---|
| (weeks) | Sprd Fctr | Activity AVG | AVG | AVG |
| 0 | 59.76 | 0.461 | 4.58 | 2933.11 |
| 1 | 61.60 | * | * | 4552.07 |
| 2 | 61.16 | 0.493 | 4.65 | 3785.41 |
| 4 | 58.18 | 0.558 | 4.89 | 5236.57 |
| 8 | 59.09 | 0.533 | 4.86 | 5159.44 |

TABLE I
Shortening:DAG oil = 0:100 25° C.

| Time | AVG | Water | % H₂O | Texture |
|---|---|---|---|---|
| (weeks) | Sprd Fctr | Activity AVG | AVG | AVG |
| 0 | 50.21 | 0.481 | 5.91 | 3286.24 |
| 1 | 49.56 | * | * | 3964.55 |
| 2 | 49.50 | 0.551 | 6.61 | 5367.29 |
| 4 | 50.89 | 0.591 | 6.35 | 8802.70 |
| 8 | 49.51 | 0.731 | 5.29 | 10982.63 |

Moderate differences were seen in the dough when the 75% DAG oil: 25% shortening blend was used as the fat source for the cookie. Though the dough was not as fluid or sensitive to temperature as the complete shortening replacement (0% shortening:100% DAG oil), it did not have sufficient structure to be easily sheeted and repeatedly worked. Consequently, it may be difficult to use the wirecut machine typically used to produce this type of cookie. Wirecut units generate a lot of scrap material as part of their normal manufacturing process; as a result, repeated working of the dough is required so that most of the dough is ultimately used to make cookies and as little of the dough is wasted as possible. As an alternative to the wirecut unit, a depositor or extrusion system may be used to more efficiently produce cookies of this shortening: oil composition on a commercial scale.

Major differences in dough rheology and machinability were seen when DAG oil was used as a complete replacement for shortening. Because sufficient solids were not present in the oil to provide structure, the dough was significantly more fluid than when shortening was incorporated at 50%, 75%, and 100% levels in the dough. Consequently, the time required to chili the dough to enable it to be machined increased from 30 to 45 minutes. In addition, it was also necessary to use a higher amount of flour to dust the dough in the complete shortening replacement as compared to the partial shortening replacements. Flour was used to dust the dough when it was sheeting in order to prevent the dough from sticking to the sheeting rolls. Scrap dough from the complete shortening replacement was also more difficult to rework using the manufacturing procedure described. The dough was more sensitive to increases in temperature and became more sticky and difficult to handle as a result of increased temperature. Therefore, if cookies utilizing DAG oil as a complete replacement for shortening were desired, it would be necessary to use a different manufacturing procedure to allow the dough to be efficiently worked and machined on an commercial scale. For example, instead of using a wirecut machine to process the dough, a depositor or extruder would be recommended. Both depositors and extruders have the capability to handle stickier, more fluid, temperature sensitive doughs; also, less scrap is generated from these processes, thereby reducing the amount of rework required.

In addition to the effects seen in dough rheology and machinability, effects in spread, texture, water activity, and moisture of the finished cookie were compared when DAG oil was used to either partially or completely replace shortening. The control, with 100% of the fat source from shortening, had a spread of 57.8. Cookies made with 75% shortening: 25% DAG oil, 50% shortening: 50% DAG oil, and 25% shortening: 75% DAG oil had comparable spread results of 63.9, 62.6, and 60.0, respectively. Though the spread of these cookies was a bit higher than the control, appearance relative to the control was similar. In contrast, cookies made with 100% DAG oil as the fat source had considerably less spread than the control, averaging 49.9. Moreover, the cookies made with 100% DAG oil had an appearance and texture more similar to a soft batch cookie as opposed to a snap cookie. Texture of cookies made with 100% shortening, 75% shortening: 25% DAG oil, and 50% shortening: 50% DAG oil was similar (all were snap type). Texture of 25% shortening: 75% DAG oil cookie was intermediate between a soft batch and snap cookie, but favored the soft batch type.

Through examination of the physical and chemical changes occurring during make up and baking of cookie dough in traditional formulas, one may explain what happens when DAG oil is added to cookie dough at various levels. At partial replacements of up to 50% shortening, DAG oil provides lubricity and increases flowability of the dough, yielding an increased spread. When DAG oil is used to replace 75% of the shortening, additional lubricity is imparted to the dough; however, the increased polarity of DAG relative to TAG allows more of the water to be retained during baking, which, in turn, allows more of the gluten to be developed before the cookie is completely baked. Gluten development decreases spread of the cookie, changing the texture from a snap type to more of a soft batch type. Differences in spread compared with formulations containing 25% DAG oil and 50% DAG oil are minimized due to added lubricity having a positive effect on spread and increased gluten development having a negative effect on spread. When DAG oil is used to completely replace shortening in the cookies, the marked increase in fluidity of the dough combined with the increased polarity of DAG relative to TAG allow even more water to be retained and a higher level of the gluten to be developed. Consequently, spread is further decreased and the texture changes from an intermediate between a snap cookie and soft batch cookie to one which solely exhibits characteristics of a soft batch cookie.

Texture readings (TA-XT plus texture analyzer, Texture Technologies, Scarsdale, N.Y.), water activity (Aqualab Series 3 TE Water Activity Meter, Decagon Devices, Pullman, Wash.), and moisture results (Mettler LP 16 drying oven and Mettler PM 100 balance, Mettler Toledo, Columbus, Ohio) support the hypothesis described above. No major differences were seen in texture (as measured by TA-XT plus or as described by informal sensory analysis), moisture, or water activity of cookies made with 100% shortening, 75% shortening: 25% DAG oil, or 50% shortening: 50% DAG oil after four weeks. Initial texture of cookies made with 25% shortening: 75% DAG oil was similar to texture of cookies made with 0-50% DAG oil; however, after four weeks, cookies made with 75% DAG oil became firmer and were reported to have a slight hard/stale texture relative to the other cookies made with 0-50% DAG oil. Water activity was higher (approximately 0.50 vs. 0.45) though moisture was about the same (4.7% vs. 4.5%) in cookies containing 75% DAG oil as compared to cookies containing 0-50% DAG oil. Cookies made with 100% DAG oil had similar texture scores to the other cookies for the first week after manufacture; however, the texture became progressively firmer and increasingly stale in subsequent weeks. After two weeks, the cookies made with 100% DAG oil were judged as too stale to be acceptable to a consumer. Both water activity (0.54 vs. 0.45) and moisture scores (6.3% vs. 4.5%) were notably higher in 100% DAG oil cookies as compared to cookies containing shortening or blends of shortening and DAG oil. To compensate for these increases in water activity and moisture, it may be necessary to add preservatives to maintain a similar shelf life to shortening based cookies.

Based on this study, the following conclusions can be drawn: Diacylglycerol oil can effectively be incorporated into cookies; DAG oil can replace up to 50% of the shortening in the formulation tested with little change in texture, appearance, water activity, or moisture in the finished cookie; DAG oil can replace up to 50% of the shortening in the formulation tested without need to change the manufacturing procedure or processing equipment used to make the cookies; if using DAG oil as a complete replacement for shortening is desired, it will be necessary to change the type of processing equipment from a wirecut system to one that is capable of handling stickier, more flowable doughs which are more sensitive to temperature than doughs made with shortening; if using DAG oil as a complete replacement for shortening is desired, it will be necessary to use some type of crumb softening agent to provide the appropriate texture to obtain a shelf life more similar to a product made with shortening; due to increased water activity and moisture in the cookies made with 100% DAG oil relative to 100% shortening, it may be necessary to redefine/reduce shelf life parameters for the product.

Investigation of Crumb Softeners

Effect of High Fructose Corn Syrup (HFCS)—Since using DAG oil as a complete replacement for shortening would improve the nutritional value of cookies and allow consumers to enjoy their favorite baked goods while deriving the nutritional benefits associated with DAG consumption, additional methods were investigated to improve the texture and keeping qualities of cookies containing DAG oil as a complete replacement for shortening. An ingredient investigated was high fructose corn syrup (HFCS). HFCS is used as a humectant in soft batch type cookies; since the cookies with 100% DAG oil had a soft batch type quality, it was reasoned that HFCS may prolong this character and improve shelf life through improved management of moisture. Formulations where HFCS was used as 15% of the granulated sugar contained in the formula were unsuccessful; since the HFCS increased the amount of sugar solubilized during mixing, the dough was extremely fluid and was too sticky to work with using available equipment. Therefore, other, more conventional crumb softeners were investigated which might have less impact on dough rheology.

Effect of traditional crumb softening agents—Additional crumb softeners investigated were distilled monoglycerides, deoiled lecithin, polyglycerol esters (PGE), and SSL. In contrast to HFCS, which is not typically thought of as a crumb softener for baked goods, the products mentioned above are typically regarded as crumb softeners in most baked goods, though they can also serve a variety of other functions in these products. In this study, the sugar cookie model formula, used above, was used. Samples were prepared and manufactured in the same manner as described previously. The same level of softener (1%, flour weight basis) was used in each treatment. Though it would be necessary to adjust the level of some of these softeners in practice (due to limitations based on flavor, permitted use in the category, etc.), each was compared at the same level so that performance properties of each product could be examined on an equivalent basis. In addition to comparing performance properties of shortening and DAG oil, performance properties of TAG oil (with oils selected to match the fatty acid composition of the DAG oil) also were examined. All oils tested were tested as pure systems; in other words, no blending of shortening, DAG oil, or TAG oil was done in this study.

Effect of traditional crumb softening agents—Distilled monoglycerides—Formulations prepared with distilled monoglycerides showed improvement in hardness values in all three treatments in initial results and results obtained one week after manufacture. However, results obtained after one week showed no improvement compared with results where no type of crumb softener was used. Results obtained support existing work in the literature which shows that there is little, if any, gelatinization of starches during the baking of cookies. Because so little water is used in the formulation relative to the amount of sugar and protein present, most of the water is absorbed by the sugar and protein, leaving little to participate in hydration of the starches. Without hydration of the starch, minimal gelatinization can occur. Without gelatinization, most of the amylose will remain within the starch granule; consequently, very little hardening of the cookie over shelf life will be caused by retrogradation of amylose. As a result, it is believed that crumb softeners that function by interfering with retrogradation of starches will have minimal impact on improving shelf life in cookies. Results are shown in Tables J-L, below (Note: Spread Factor=W/T*10).

TABLE J
1% Distilled Monoglyceride (Panalite 90 DK*) w/Shortening

| Time | AVG | Water | % H₂O | Texture |
|---|---|---|---|---|
| (weeks) | Sprd Fctr | Activity AVG | AVG | AVG |
| 0 | 58.05 | N/A | N/A | 1853.61 |
| 1 | 59.14 | N/A | N/A | 3445.37 |
| 2 | 60.14 | 0.577 | 5.25 | 4576.93 |
| 4 | 57.64 | 0.589 | 5.32 | 6118.76 |
| 8 | 60.38 | 0.643 | 4.63 | 6349.13 |

*distilled monoglycerides, commercially available from ADM

TABLE K
1% Distilled Monoglyceride (Panalite 90 DK) w/DAG oil

| Time | AVG | Water | % H₂O | Texture |
|---|---|---|---|---|
| (weeks) | Sprd Fctr | Activity AVG | AVG | AVG |
| 0 | 53.74 | N/A | N/A | 1487.44 |
| 1 | 50.59 | N/A | N/A | 3708.71 |
| 2 | 51.25 | 0.645 | 6.99 | 5873.49 |
| 4 | 51.12 | 0.659 | 6.88 | 7750.77 |
| 8 | 50.45 | 0.763 | 6.29 | 8664.97 |

TABLE L
1% Distilled Monoglyceride (Panalite 90 DK) w/TAG oil

| Time | AVG | Water | % H₂O | Texture |
|---|---|---|---|---|
| (weeks) | Sprd Fctr | Activity AVG | AVG | AVG |
| 0 | 61.99 | N/A | N/A | 1502.05 |
| 1 | 61.53 | N/A | N/A | 2677.96 |
| 2 | 58.45 | 0.602 | 6.53 | 3824.49 |
| 4 | 60.80 | 0.609 | 5.54 | 5658.52 |
| 8 | 58.48 | 0.714 | 5.59 | 7171.98 |

Deoiled lecithin—Formulations prepared with deoiled lecithin showed large increases in spread in all treatments. Spread values increased from 57.6 to 66.8 in cookies made with shortening, from 50.0 to 57.8 in cookies made with DAG oil, and from 60.7 to 69.0 in cookies made with TAG oil. Increases in spread resulted from modification of dough rheology prior to baking, which was noted in each of the three doughs immediately after make-up. Because the doughs made with liquid oils (either DAG or TAG oils) were inherently more fluid without the addition of deoiled lecithin, the addition of deoiled lecithin caused the doughs to be stickier and more difficult to handle then when the doughs were processed without additives. Since the dough made with shortening had solid fat present to help build structure and provide the desired characteristics in handling until the dough was baked, addition of deoiled lecithin increased fluidity of the shortening-based dough without negatively affecting its handling or machining properties.

Improvements in texture were noted in all three treatments when deoiled lecithin was used; however, more pronounced and lasting effects were seen in shortening and TAG oil treatments than in the DAG oil treatment. In fact, when deoiled lecithin was used as a crumb softener in cookies made with shortening or TAG oil, similar texture readings were recorded at four weeks in the deoiled lecithin treatments as were recorded initially in the cookies baked without additives. In contrast, the cookies made with DAG oil and deoiled lecithin had similar texture readings at two weeks as were recorded initially in the cookies made without additives; however, at four weeks, a crumbly, stale texture began to emerge. Therefore, it was reasoned that deoiled lecithin would not be a viable crumb softener to extend the shelf life of cookies utilizing DAG oil as a complete replacement for shortening. Deoiled lecithin may be a viable crumb softener for cookies using TAG as a complete replacement for shortening; however, the level of deoiled lecithin would most likely need to be reduced as there were very slight but notable off-flavors and aromas present from the lecithin at this inclusion level. Results are show in Tables M-O, below.

TABLE M
1% Deoiled Lecithin (Ultralec*) w/Shortening

| Time | AVG | Water | % H₂O | Texture |
|---|---|---|---|---|
| (weeks) | Sprd Fctr | Activity AVG | AVG | AVG |
| 0 | 69.65 | N/A | N/A | 2071.35 |
| 1 | 64.08 | N/A | N/A | 2579.06 |
| 2 | 66.05 | 0.461 | 4.16 | 3411.92 |
| 4 | 67.30 | 0.457 | 4.41 | 3054.63 |
| 8 | 64.58 | 0.509 | 3.69 | 4129.46 |

*Ultralec is ultrafiltered, deoiled lecithin, commercially available from ADM.

TABLE N
1% Deoiled Lecithin (Ultralec) w/DAG oil

| Time | AVG | Water | % H₂O | Texture |
|---|---|---|---|---|
| (weeks) | Sprd Fctr | Activity AVG | AVG | Mean AVG |
| 0 | 55.84 | N/A | N/A | 2550.81 |
| 1 | 59.39 | N/A | N/A | 2816.06 |
| 2 | 56.10 | 0.543 | 6.33 | 3899.75 |
| 4 | 60.20 | 0.590 | 6.21 | 6103.99 |
| 8 | 55.76 | 0.650 | 6.69 | 7467.44 |

TABLE O
1% Deoiled Lecithin (Ultralec) w/TAG oil

| Time | AVG | Water | % H₂O | Texture |
|---|---|---|---|---|
| (weeks) | Sprd Fctr | Activity AVG | AVG | AVG |
| 0 | 77.04 | N/A | N/A | 977.61 |
| 1 | 68.14 | N/A | N/A | 2026.25 |
| 2 | 62.74 | 0.439 | 4.74 | 3334.32 |
| 4 | 68.06 | 0.512 | 4.69 | 2819.75 |
| 8 | 64.79 | 0.544 | 4.48 | 4228.27 |

Polyglycerol esters—In addition to distilled monoglycerides and deoiled lecithin, two different types of polyglycerol esters (PGE) were investigated to determine their utility as crumb softeners in cookies. The two types selected were a triglycerol monostearin (3-PGE) and a decaglycerol monostearin (10-PGE). The different PGE's were selected to determine if degree of polymerization of the polyglycerol chains had an effect on crumb softening power. Minor improvements were seen when 3-PGE was used; however, because the improvements were not significant and likely would not make the necessary impact for the desired shelf life of the cookie, no further exploration was done with this additive.

Though 3-PGE showed only minor improvements in ability to extend shelf life, notable improvements were seen when 10-PGE was used. Use of 10-PGE in cookies made with DAG oil increased spread (50.0 to 57.1), yielding a spread comparable to cookies made with shortening (57.6). Though similar results in spread were seen when deoiled lecithin was used in DAG oil-based cookies (57.8), no differences in dough rheology were noted when 10-PGE was used. In addition, DAG oil-based cookies made with 10-PGE had softer texture for a longer period of time than DAG oil-based cookies made with deoiled lecithin. Despite improvements in texture, spread, and dough rheology, improvements were not sufficient to yield more than a four week shelf life in these cookies; thus, the use of 10-PGE as the sole crumb softening agent in DAG oil-based cookies was considered insufficient. Results are shown in Tables P-U, below

TABLE P
1% Triglyceryl Monostearate (Polyaldo TGMS) w/Shortening

| Time | AVG | Water | % H₂O | Texture |
|---|---|---|---|---|
| (weeks) | Sprd Fctr | Activity AVG | AVG | AVG |
| 0 | 63.14 | N/A | N/A | 3040.82 |
| 1 | 61.52 | N/A | N/A | 3858.00 |
| 2 | 60.83 | 0.425 | 4.54 | 4130.40 |
| 4 | 64.94 | 0.443 | 4.57 | 3957.66 |
| 8 | 64.80 | 0.455 | 2.25 | 3827.71 |

*Polyaldo TGMS is Triglyceryl Monostearate, and is commercially available from Lonza, Fair Lawn, N.J.

TABLE Q
1% Triglyceryl Monostearate (Polyaldo TGMS) w/DAG oil

| Time | AVG | Water | % H₂O | Texture |
|---|---|---|---|---|
| (weeks) | Sprd Fctr | Activity AVG | AVG | AVG |
| 0 | 49.50 | N/A | N/A | 2070.79 |
| 1 | 49.45 | N/A | N/A | 3993.66 |
| 2 | 47.91 | 0.580 | 4.31 | 4464.05 |
| 4 | 52.99 | 0.534 | 5.71 | 6537.88 |
| 8 | 49.05 | 0.662 | 5.06 | 10740.71 |

TABLE R
1% Triglyceryl Monostearate (Polyaldo TGMS) w/TAG oil

| Time | AVG | Water | % H₂O | Texture |
|---|---|---|---|---|
| (weeks) | Sprd Fctr | Activity AVG | AVG | AVG |
| 0 | 56.90 | N/A | N/A | 1759.56 |
| 1 | 57.73 | N/A | N/A | 3376.87 |
| 2 | 56.61 | 0.527 | 5.20 | 4178.74 |
| 4 | 60.73 | 0.548 | 5.21 | 4475.11 |
| 8 | 57.39 | 0.652 | 4.59 | 8145.37 |

TABLE S
1% Decaglyceryl Monostearate (Polyaldo 10-1-S*) w/Shortening

| Time | AVG | Water | % H₂O | Texture |
|---|---|---|---|---|
| (weeks) | Sprd Fctr | Activity AVG | AVG | AVG |
| 0 | 59.83 | N/A | N/A | 1630.53 |
| 1 | 60.26 | N/A | N/A | 2653.51 |
| 2 | 60.14 | 0.477 | 5.14 | 2921.33 |
| 4 | 60.18 | 0.469 | 4.38 | 3373.79 |
| 8 | 62.09 | 0.651 | 4.74 | 5065.18 |

*Polyaldo 10-1-S is decaglyceryl monostearate, and is commercially available from Lonza, Fairlawn, N.J.

TABLE T
1% Decaglyceryl Monostearate (Polyaldo 10-1-S) w/DAG oil

| Time | AVG | Water | % H₂O | Texture |
|---|---|---|---|---|
| (weeks) | Sprd Fctr | Activity AVG | AVG | AVG |
| 0 | 56.81 | N/A | N/A | 1942.24 |
| 1 | 58.15 | N/A | N/A | 2619.33 |
| 2 | 56.98 | 0.509 | 6.21 | 3867.50 |
| 4 | 56.39 | 0.531 | 5.45 | 4296.77 |
| 8 | 59.13 | 0.679 | 4.64 | 6865.97 |

TABLE U
1% Decaglyceryl Monostearate (Polyaldo 10-1-S) w/TAG oil

| Time | AVG | Water | % H₂O | Texture |
|---|---|---|---|---|
| (weeks) | Sprd Fctr | Activity AVG | AVG | AVG |
| 0 | 59.64 | N/A | N/A | 1271.62 |
| 1 | 56.96 | N/A | N/A | 1987.80 |
| 2 | 55.85 | 0.578 | 6.49 | 2432.31 |
| 4 | 61.98 | 0.626 | 5.42 | 4923.17 |
| 8 | 62.04 | 0.717 | 4.34 | 5375.88 |

Similar textures were obtained (at equivalent points in shelf life) when either 10-PGE or deoiled lecithin was used in shortening-based cookies. Because little change was seen in the dough made with 10-PGE prior to baking, little change was noted in cookie spread between the dough made with 10-PGE and the control dough without added crumb softeners (60.1 vs. 57.6, respectively). Since dough handling properties were comparable to dough handling properties of the cookies without added crumb softeners, it is believed that a distinct advantage in dough handling and machining could be gained by using 10-PGE instead of deoiled lecithin as a crumb softener in shortening-based cookies. Because 10-PGE provided adequate crumb softening for a sufficient length of time without negatively impacting dough handling or machining properties, it was judged to be an effective crumb softener for shortening-based cookies.

Use of 10-PGE in TAG oil-based cookies resulted in similar spread as shortening-based cookies without added crumb softeners (58.6 vs. 57.6, respectively). Despite providing more consistent spread relative to the control, 110-PGE could not provide sufficient crumb softening over the desired shelf life of the cookies; thus the use of 10-PGE as the sole crumb softening agent in TAG oil-based cookies was considered insufficient.

Lastly, it should be noted that 10-PGE had a different physical form than any of the other crumb softening agents tested. 10-PGE was a hard, plastic product whereas all other crumb softeners tested were beaded products. Due to the difference in physical form, 10-PGE had to be melted in with a small portion of the formula oil/fat and then subsequently cooled before it could be added in with the remaining oil/fat to be used in the study. Beaded crumb softeners, on the other hand, could be added in directly with the other dry ingredients at the creaming stage. Consequently, though many of the results obtained with 10-PGE were favorable, practical use of this additive may be somewhat limited in a commercial setting due to the extra handling required.

Sodium stearoyl lactylate (SSL)—Of the crumb softeners tested, SSL appears to be the most promising in DAG oil. Use of SSL increased spread in DAG oil-based cookies from 50.0 to 58.5, making spread of these cookies similar to the shortening-based control without additives. In addition, use of SSL as a crumb softening agent did not change rheological properties of the dough prior to baking. Maintenance of dough properties prior to baking enabled the dough to be more easily handled and machined than when other crumb softeners, like deoiled lecithin, were used. In addition to the positive change seen in spread when SSL was used in cookies containing DAG oil, positive changes were also noted in texture. In fact, when SSL was used as a crumb softener in cookies containing DAG oil, similar texture readings were recorded at four weeks in the SSL treatments as were recorded initially in the cookies baked without additives.

Cookies made with shortening displayed similar trends with respect to spread; use of SSL in these cookies increased spread from 57.6 to 61.6. As with their DAG oil counterparts, no significant changes were seen in dough functionality or handling when SSL was used in cookies made with shortening. In addition to providing a softer texture in cookies made with DAG oil, use of SSL also provided a softer texture in cookies made with shortening; however, use of deoiled lecithin provided the softest texture over time in shortening-based cookies.

Though use of SSL as a crumb softener provides some distinct advantages over the other crumb softeners tested, it is important to note that this study was designed to compare all crumb softeners equally; thus, SSL was used in the present study at a level exceeding the level permitted in cookies by the Code of Federal Regulations (CFR). Therefore, to fully elucidate the benefit of SSL in cookies for interests of commercial manufacture, additional testing at levels within permitted use requirements may be necessary. Results are shown in Tables V and W.

TABLE V
1% SSL* w/Shortening

| Time | AVG | Water | % H₂O | Texture |
|---|---|---|---|---|
| (weeks) | Sprd Fctr | Activity AVG | AVG | AVG |
| 0 | 59.69 | N/A | N/A | 1896.97 |
| 1 | 64.67 | N/A | N/A | 3371.79 |
| 2 | 62.44 | 0.489 | 5.13 | 2941.23 |
| 4 | 59.76 | 0.512 | 5.64 | 3876.23 |
| 8 | 66.55 | 0.515 | 3.80 | 3902.03 |

*SSL is commercially available as Paniplus SK from ADM

TABLE W
1% SSL w/DAG oil

| Time | AVG | Water | % H₂O | Texture |
|---|---|---|---|---|
| (weeks) | Sprd Fctr | Activity AVG | AVG | AVG |
| 0 | 56.89 | N/A | N/A | 1723.16 |
| 1 | 59.09 | N/A | N/A | 2716.84 |
| 2 | 57.13 | 0.492 | 5.72 | 2517.82 |
| 4 | 60.83 | 0.508 | 6.09 | 3225.82 |
| 8 | 63.00 | 0.605 | 4.43 | 5415.62 |

Based on the work described above, the following conclusions can be drawn: crumb softeners can be used to improve shelf life of cookies made from liquid oil sources (either DAG-based or TAG-based); neither distilled monoglycerides nor 3-PGE appear to be appropriate crumb softening agents to extend shelf life in cookies; 10-PGE appears to have limited utility as a crumb softener due to additional handling requirements which would be difficult to manage in commercial manufacture; use of deoiled lecithin as a crumb softener holds promise if appropriate equipment capable of handling more fluid, sticky doughs is used; deoiled lecithin would appear to need to be used at levels lower than 1% (flour weight basis) to avoid perception of off-flavors or aromas; and, of the crumb softeners tested, SSL was the most functional in DAG oil, however, for SSL to be used as a crumb softening agent in commercial manufacture, its use level would need to be reduced to meet requirements as defined by the CFR. Therefore, to meet the criteria established for acceptable use levels, flavor, dough handling, machinability, and shelf life characteristics of cookies made with DAG oil or any other liquid oil, it may be prudent to select a combination of crumb softeners to obtain optimum performance.

Impact of protein on dough rheology—When experiments were first initiated, the protein content of the pastry flour used to make the cookies was around 9%. As the experiments progressed, there was a change in crop year for the wheat used to produce the flour. Consequently, the protein content in the pastry flour received for subsequent work dropped from 9% to 8%. This reduction in protein content resulted in more flowable, sticky doughs that required much longer chill times to become moderately workable. Because it was an objective to use liquid oils instead of plastic fats and to keep the calorie contributions from the cookies constant (no added sugar or fat to provide structure to aid in handling and/or machinability), experimentation was done to determine if increasing protein content could restore handling and machinability of the dough without having negative effects on appearance or texture.

To increase the level of protein, a flour from unbleached hard red winter wheat was selected. It was reasoned that this approach would provide a flour that was of similar quality and type to the original pastry flour used in previous experiments. When substitutions were made to provide a protein content of 9% in the finished flour used to make the cookies, handling and machining properties of the cookies were restored to the original parameters. In addition, no differences were observed in texture or appearance between cookies made with the original pastry flour and cookies made from a blend of pastry flour and unbleached hard red winter wheat. Thus, protein content of the flour must be tightly controlled to make a product of consistent quality if complete replacement of shortening with liquid oils is desired.

### EXAMPLE 7

### Breads and Bread Dough

Breads and bread dough may be prepared essentially in the manner known in the art, but with the substitution of DAG oil for all or part of other oils or fats used in preparation of the bread. For example, bread can be prepared by mixing warm water, salt, sugar and yeast with oil containing DAG oil; mixing flour into the liquid to produce a dough; kneading the dough; allowing the dough to rise; optionally shaping the dough; and baking the dough. Dough can be stored, and optionally frozen, after kneading and prior to or after one or more rising steps.

### EXAMPLE 8

### Nutritional Beverages

A nutritional beverage is provided that contains, by weight, about 0.1% to about 15% protein; about 1% to about 5% diacylglycerol oil; and about 10% to about 20% sweetener. Optionally, the beverage contains thickening agents, vitamins and flavorings. Two examples of such nutritional beverage formulations are provided in Tables X and Y. Specifically a chocolate meal replacement beverage and a vanilla nutritional drink are provided in which there is no substantial gustatory difference between those drinks containing equivalent amounts of DAG and TAG oils.

TABLE X
Chocolate Meal Replacement Beverage

| Ingredient | % (by weight) |
|---|---|
| ADM ProFam 892^{A} | 3.95 |
| Enova ™ Diacylglycerol Oil | 1.00 |
| 36 DE Corn Syrup Solids^{B} | 6.55 |
| ADM CornSweet 42 HFCS^{C} | 9.00 |
| ADM Dutch Cocoa D-11-S^{D} | 1.92 |
| Budenheim micronized TCP^{E} | 0.50 |
| FMC Carrageenan SD 389^{F} | 0.03 |
| FMC Avicel RC-591F^{G} | 0.30 |
| David Michael #1398 N&A Crmy Vanilla^{H} | 0.25 |
| Water | 76.50 |
| Total | 100.00 |

^{A}ADM ProFam 892 is soy protein isolate and is commercially available from ADM.
^{B}36 DE Corn Syrup Solids is commercially available from Grain Processing Corporation.
^{C}ADM CornSweet 42 HFCS is 42% HFCS and is commercially available from ADM.
^{D}ADM Dutch Cocoa D-11-S is alkalized cocoa powder and is commercially available from ADM.
^{E}Budenheim micronized TCP is fine-grind tri-calcium phosphate and is commercially available from Budenheim.
^{F}FMC Carrageenan SD 389 is carageenan and is commercially available from FMC Corporation.
^{G}FMC Avicel RC-591F is cellulose gel and is commercially available from FMC Corporation.
^{H}David Michael #1398 N&A Crmy Vanilla is commercially available from David Michael.

The beverage of Table X is prepared by: hydrating ProFam 892 in 50° C. water for 15 minutes; dry blending all powdered ingredients; adding the powdered ingredients to hydrated protein; mixing 5 minutes; adding the oil and HFCS; mixing 5 additional minutes; ultra high temperature pasteurization at 140° C. for 6-8 seconds; homogenizing at 2500/500 psi. using a 2-stage homogenizer and cooling and packaging into desired containers.

TABLE Y
Vanilla Nutritional Drink

| Ingredient | % (by weight) |
|---|---|
| ADM ProFam 892 | 6.00 |
| Enova ™ Diacylglycerol Oil | 2.50 |
| ADM Crystalline Fructose^{A} | 7.00 |
| ADM 15 DE Maltodextrin^{B} | 5.00 |
| ADM K Citrate^{C} | 0.75 |
| FMC Carrageenan SD 389 | 0.02 |
| FMC Avicel RC-591F | 0.20 |
| Salt | 0.10 |
| David Michael #22821 N&A Vanilla Flavor^{D} | 0.15 |
| David Michael #535 Nat. Cream Flavor^{D} | 0.10 |
| Budenheim Micronized TCP | 0.40 |
| ADM Vit/Min Premix^{E} | 0.05 |
| ADM MDG 40-HVK^{F} | 0.15 |
| Water | 77.58 |
| Total | 100.00 |

^{A}commercially available from ADM.
^{B}ADM 15 DE Maltodextrin is Clintose CR 15 and is commercially available from ADM.
^{C}commercially available from ADM.
^{D}commercially available from David Michael.
^{E}ADM Vit/Min Premix is a vitamin and mineral premix and is commercially available from ADM.
^{F}ADM MDG 40-HVK is mono and diglycerides and is commercially available from ADM.

The beverage of Table Y is prepared by: hydrating ProFam 892 in 50° C. water for 15 min; dry blending all powdered ingredients; adding the powdered ingredients to the hydrated protein; mixing 5 minutes; melting the mono and diglycerides into oil; adding them to the beverage and mixing for an additional 5 minutes, ultra high temperature pasteurization at 140° C. for 6-8 seconds; homogenizing at 2500/500 psi. using a 2-stage homogenizer and cooling and packaging into desired containers.

Many modifications and variations of the embodiments described herein may be made without departing from the scope, as is apparent to those skilled in the art. The specific embodiments described herein are offered by way of example only.

What is claimed is:

1. A food product selected from the group consisting of a cake, a cake batter, a muffin, a muffin batter, a brownie, a brownie batter, a bread, a bread dough, a cookie, and a cookie dough, wherein the food product comprises diacylglycerol oil.

2. The food product of claim 1, wherein the diacylglycerol oil is used in place of all of at least one of a triacylglycerol oil and a triacylglycerol fat.

3. The food product of claim 1, wherein the diacylglycerol oil comprises from about 40% to 100% by weight 1,3-diglycerides.

4. The food product of claim 3, wherein the diacylglycerol oil comprises at least about 45% by weight 1,3-diglycerides.

5. The food product of claim 4, wherein the diacylglycerol oil comprises at least about 50% by weight 1,3-diglycerides.

6. The food product of claim 3, wherein the fatty acid component of the 1,3-diglycerides comprises from about 50% to 100% by weight unsaturated fatty acids.

7. The food product of claim 6, wherein the fatty acid component of the 1,3-diglycerides comprises at least about 93% by weight unsaturated fatty acids.

8. The food product of claim 7, wherein the fatty acid component of the 1,3-diglycerides comprises at least about 95% by weight unsaturated fatty acids.

9. The food product of claim 1, wherein diacylglycerol oil and triacylglycerol oil/fat are present in a ratio of from about 1:100 to 100:0 diacylglycerol oil to triacylglycerol oil/fat.

10. The food product of claim 1, wherein the food product is selected from the group consisting of a cookie and a cookie dough.

11. The food product of claim 10, further comprising a crumb softener.

12. The food product of claim 11, wherein the crumb softener is selected from the group consisting of high fructose corn syrup, deoiled lecithin, a polyglycerol ester, and sodium stearoyl lactylate.

13. The food product of claim 11, wherein the crumb softener is sodium stearoyl lactylate.

14. The food product of claim 13, comprising about 1% by weight sodium stearoyl lactylate.

15. The food product of claim 10, wherein the food product is a cookie dough comprising flour having protein content greater than about 8% by weight.

16. The food product of claim 10, wherein the food product is a cookie made from a cookie dough having protein content greater than about 8% by weight.

17. The food product of claim 1, wherein the food product is selected from the group consisting of a cake and a cake batter.

18. The food product of claim 1, wherein the food product is selected from the group consisting of a muffin and a muffin batter.

19. The food product of claim 1, wherein the food product is selected from the group consisting of a brownie and a brownie batter.

20. A food product selected from the group consisting of a cake, a cake batter, a muffin, a muffin batter, a brownie, a brownie batter, a bread, a bread dough, a cookie, and a cookie dough, wherein the food product comprises an oil-in-water emulsion comprising diacylglycerol oil.

21. The food product of claim 20, wherein diacylglycerol oil is used in the oil-in-water emulsion in place of some or all of at least one of a triacylglycerol oil and a triacylglycerol fat.

22. The food product of claim 21, wherein the oil-in-water emulsion further comprises an emulsifier.

23. The food product of claim 20, wherein the emulsifier is selected from the group consisting of standard lecithin, acetylated lecithin, hydroxylated lecithin, modified lecithin, sodium stearoyl lactate, and sodium stearoyl lactate in combination with at least one material selected from the group consisting of distilled monoglycerides, monodiglycerides, ethoxylated monoglycerides, monodiglycerides, polysorbates, polyglycerol esters, PGPR, sucrose esters, succinylated monoglycerides, acetylated monoglycerides, lactylated monoglycerides, sorbitan esters, DATEMs, soy protein isolate, soy protein concentrate, soy protein flour, whey protein isolate, whey protein concentrate, sodium caseinate, and calcium caseinate.

24. The food product of claim 22, wherein the emulsifier is standard lecithin.

25. The food product of claim 22, wherein the emulsifier is sodium stearoyl lactate.

26. The food product of claim 20, wherein the diacylglycerol oil comprises from about 40% to 100% by weight 1,3-diglycerides.

27. The food product of claim 20, wherein the diacylglycerol oil comprises at least about 45% by weight 1,3-diglycerides.

28. The food product of claim 20 wherein the diacylglycerol oil comprises at least about 50% by weight 1,3-diglycerides.

29. The food product of claim 26, wherein the fatty acid component of the 1,3-diglycerides comprises from about 50% to 100% by weight unsaturated fatty acids.

30. The food product of claim 26, wherein the fatty acid component of the 1,3-diglycerides comprises at least about 93% by weight unsaturated fatty acids.

31. The food product of claim 26, wherein the fatty acid component of the 1,3-diglycerides comprises at least about 95% by weight unsaturated fatty acids.

32. The food product of claim 22, wherein diacylglycerol oil and triacylglycerol oil/fat are present in a ratio of from about 1:100 to 100:0 diacylglycerol oil to triacylglycerol oil/fat.

33. A beverage comprising, by weight: about 0.1% to about 15% protein; about 1% to about 5% diacylglycerol oil; and about 10% to about 20% sweetener.

34. The beverage of claim 31, further comprising at least one of a thickening agent, a vitamin, and a flavoring.

35. A method for preparing a food product, the method comprising: preparing one of a dough and a batter comprising diacylglycerol oil.

36. The method of claim 35, further comprising: processing the one of the dough and batter into a finished food product.

37. The method of claim 35, wherein the food product is selected from the group consisting of a cake, a muffin, a brownie, a bread, and a cookie.

38. The method of claim 35, wherein the diacylglycerol oil is emulsified.

39. The method of claim 35 wherein the diacylglycerol oil comprises at least about 50% by weight 1,3-diglycerides.

40. The method of claim 35, wherein the fatty acid component of the 1,3-diglycerides comprises from about 50% to 100% by weight unsaturated fatty acids.

41. The method of claim 35, wherein the fatty acid component of the 1,3-diglycerides comprises at least about 95% by weight unsaturated fatty acids.

42. The method of claim 35, wherein diacylglycerol oil and triacylglycerol oil/fat are present in a ratio of from about 1:100 to 100:0 diacylglycerol oil to triacylglycerol oil/fat.

43. A food product prepared according to a method comprising: preparing one of a dough and a batter comprising diacylglycerol oil.

44. The food product of claim 43, wherein the method further comprises: processing the one of the dough and batter into a finished food product.

45. A method of improving health benefits of a fat/oil-containing food product selected from the group consisting of a cake, a cake batter, a muffin, a muffin batter, a brownie, a brownie batter, a bread, a bread dough, a cookie, and a cookie dough, comprising: preparing the food product with fat/oil comprising diacylglycerol oil.
